(19) United States
(12) Patent Application Publication
(10) Pub. No.: US 2015/0310766 A1
(43) Pub. Date: Oct. 29, 2015

(54) Portable Multilingual Braille Reader With Words Translator Device And Method

(71) Applicants: Saleh A. Alshehri, Jubail Industrial City (SA); Majid A. Alfifi, Dammam (SA)

(72) Inventors: Saleh A. Alshehri, Jubail Industrial City (SA); Majid A. Alfifi, Dammam (SA)

(21) Appl. No.: 14/578,751

(22) Filed: Dec. 22, 2014

Related U.S. Application Data
(60) Provisional application No. 61/985,033, filed on Apr. 28, 2014.

(51) Int. Cl. G09B 21/00

(52) U.S. Cl. CPC G09B 21/004

(57) ABSTRACT

A portable multilingual braille reader with words translator device and method for the ease and convenience in reading braille is disclosed. In an embodiment, the portable multilingual braille reader with words translator device and method generally includes a protective casing adapted to receive a portable electronic device, a language processing unit attached to said protective casing; said language processing unit to process language data received from said portable electronic device; and a braille cell to receive processed language data from said language translation processing unit.

### CROSS REFERENCE TO RELATED APPLICATIONS

I hereby claim benefit under Title 35, United States Code, Section 119(e) of U.S. provisional patent application Ser. No. 61/985,033 filed Apr. 28, 2014. The 61/985,033 application is currently pending. The 61/985,033 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an electronic reading device and method thereof, and more specifically it relates to a portable multilingual braille reader with words translator and method thereof for the ease and convenience in reading braille.

2. Description of the Related Art

Any discussion of the related art throughout the specification should in no way be considered as an admission that such related art is widely known or forms part of common general knowledge in the field.

In today's high technology world, smartphones, tablets, and other portable electronics devices are ubiquitous. While these products have several functionalities and uses that have become indispensable to the blind or visually impaired, these products, by and large, do not accommodate to the specific needs and desires of this category of users.

For instance, as products have moved further to touch oriented smooth flat screens, it is difficult for blind individuals to use these products with ease. Often times, “apps” may be accidentally moved or removed, thus making it difficult to locate and quickly access these resources. Other times, the orientation of the screen can also be changed, which can also cause frustration in attempting to use such products.

Further, as these electronic devices become smaller, thinner, and lighter in weight, it has become increasingly more difficult for the blind to adequately protect these products from accidental damage.

Moreover, for the blind or low vision individuals, braille continues to be the most practical communication method of reading and writing available. In this manner of communication, a pattern of raised bumps following a particular order represent alphanumeric letters, abbreviations and contractions, and various short-hands. To read a particular text, a blind person places a finger over the braille pattern and through finger sensing, the person is able to understand particular letters and words.

While reading braille can be somewhat efficiently performed with the use of embossed paper, refreshable braille displays or braille terminals (for example, in the desktop computer context), there is a need for a convenient method to read braille in conjunction with smartphones, tablets, e-readers, or other similar electronic devices. Moreover, there is a need to provide adequate protection of such devices.

Also, braille reading products lack distinct features which would greatly aid in the comfort and ease of use in reading braille. Conventional braille readers provide the blind with the ability to read printed text material in a single language, but lack the ability to do language translation.

Because of the inherent problems with the related art, there is a need for a new and improved portable multilingual braille reader with words translator for the ease and convenience in reading braille.

### BRIEF SUMMARY OF THE INVENTION

The invention generally relates to a new and improved portable multilingual braille reader with words translator for the ease and convenience in reading braille. There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a front upper perspective view in accordance with embodiments of the present invention.

FIG. 2 illustrates an exploded upper perspective view in accordance with embodiments of the present invention.

FIG. 3 illustrates a front upper perspective view of the protective casing in accordance with embodiments of the present invention.

FIG. 4 illustrates a front view of the protective casing in accordance with embodiments of the present invention.

FIG. 5 illustrates a rear view of the protective casing in accordance with embodiments of the present invention.

FIG. 6 illustrates a side view of the right side of the protective casing in accordance with embodiments of the present invention.

FIG. 7 illustrates a side view of the left side of the protective casing in accordance with embodiments of the present invention.

FIG. 8 illustrates a front upper perspective view in accordance with embodiments of the present invention.

FIG. 9 illustrates a front upper perspective view in accordance with embodiments of the present invention.

FIG. 10 illustrates a front upper perspective view of an alternative embodiment of the present invention comprised of a standalone configuration.

FIG. 11 shows a flow diagram of text image conversion in accordance with embodiments of the present invention.

FIG. 12 shows a flow diagram of text image translation and conversion in accordance with embodiments of the present invention.

FIG. 13 is a cross sectional view taken along line 13-13 of FIG. 1 illustrating the mobile electronic device housed within the protective casing while allowing access to the touch screen of the mobile device.

### DETAILED DESCRIPTION OF THE INVENTION

### A. Overview.

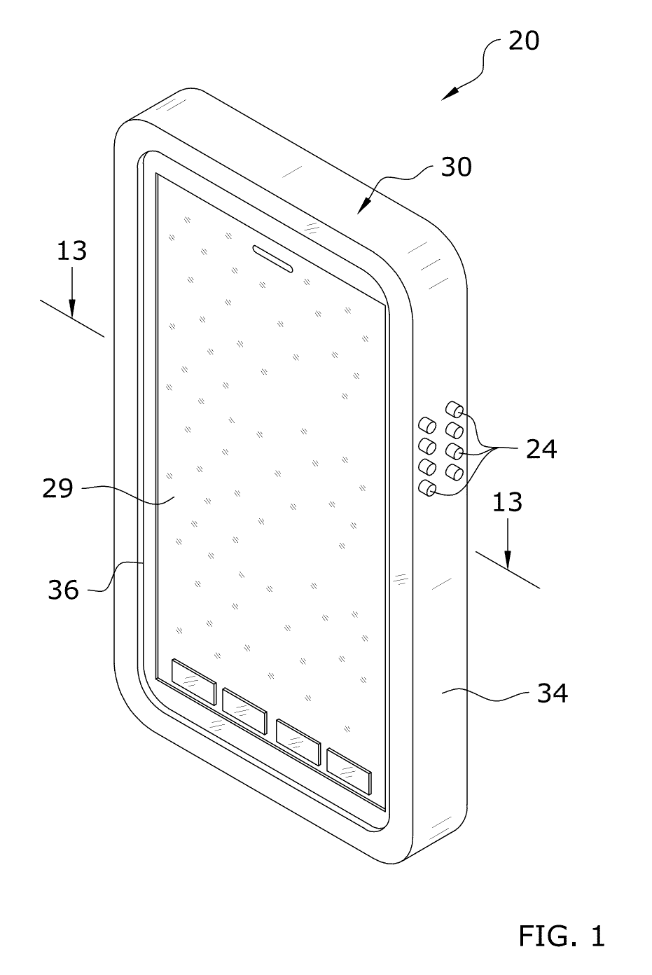

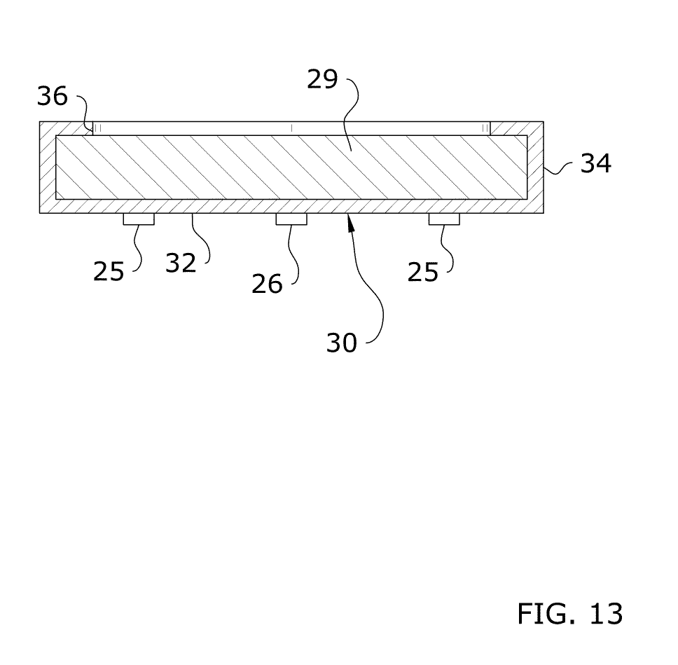

Turning now descriptively to the drawings, in which similar reference characters denote similar elements throughout the several views, FIGS. 1 through 9, and 11 through 13, illustrate a portable multilingual braille reader with words translator (20, 40) (hereinafter “braille reader”), which comprises a protective casing adapted to receive a portable electronic device, a language processing unit attached to the protective casing, the language processing unit to process language data received from the portable electronic device, and a braille cell to receive processed language data from the language translation processing unit.

B. Portable Multilingual Braille Reader Protective Case with Words Translator.

Example embodiments of the present invention include a portable braille multilingual reader device protective case with words translator. The braille reader (20) enables blind and visually impaired people to comprehend any displayable outputted terminology of language data or language information of printed text characters or images (hereinafter “text images”) in various customizable language preferences. The text images may be displayed using any conventional display technology including, but not limited to, LCD, OLED, or electrophoretic displays.

Embodiments of the present invention include: a microprocessor module (22), a memory module (23), a braille cell (24), a braille keyboard (25), an enter key button (or submission button) (26), and a protective cover, casing or encasing (hereinafter “protective cover” or “protective casing”) (30). Advantageously, these above components may be integrated into a single cover which serves as a protective encasing for a portable electronic device (hereinafter “associated portable device”) (e.g. smartphone, tablet, e-reader or other handheld and/or wearable device) (29).

FIG. 1 illustrates a front upper perspective view of the braille reader and words translator portable device (20) in accordance with embodiments of the present invention. As shown in FIG. 1, an example front outer perspective of the braille reader includes a protective casing (30) and braille cell (24). The braille cell may be comprised of any device capable of displaying braille characters such as a refreshable braille display or a braille terminal. The braille cell (24) can be comprised of the braille cell disclosed in U.S. Pat. No. 4,473,356 to Fernando et al. which is incorporated herein by reference. For example, the braille cell (24) is shown to be located on the upper right hand side portion of the braille reader (20) protruding outward from the protective cover (30). Advantageously, for ease and comfort in use, the braille cell (24) can be located in the upper right hand side portion. However, in other embodiments, the braille reader (20) contemplates the location of the braille cell (24) along any other side portion of braille reader (20) including the lower right hand side portion, the upper left hand portion, and lower left hand portion.

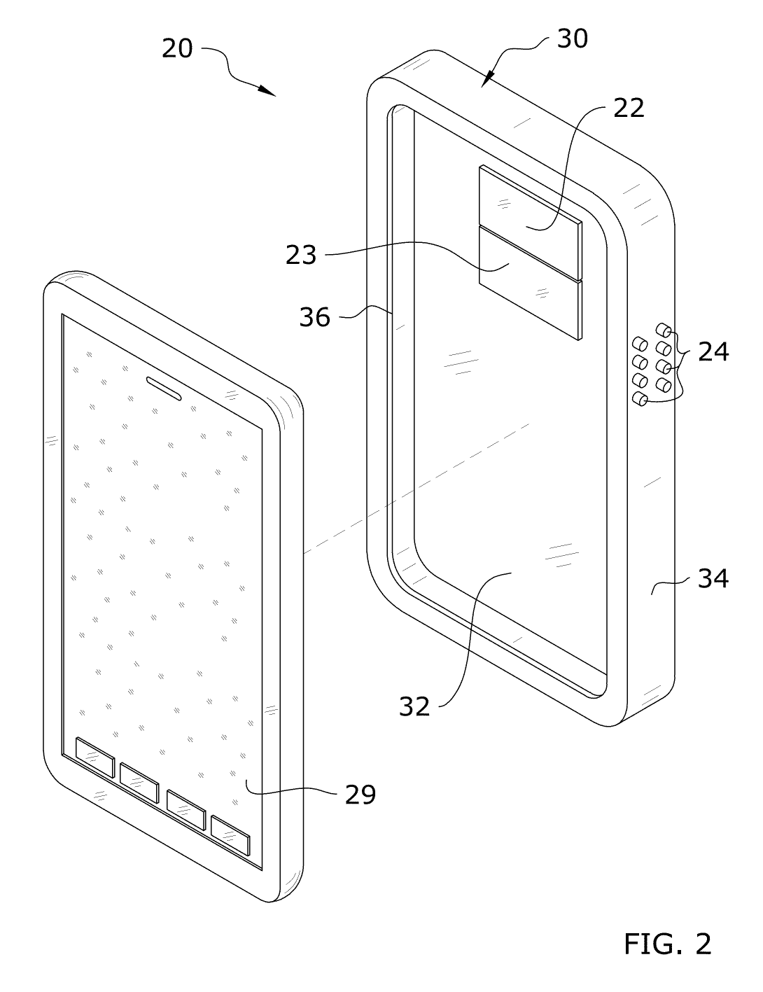

FIG. 2 illustrates an exploded front upper perspective view of the braille reader and words translator portable device (20) in accordance with embodiments of the present invention. The protective casing (30) is formed into a shape and structure that is adapted for receiving, storing and protecting the portable electronic device (29) similar to a conventional mobile phone case. The protective casing (30) preferably has a back wall (32), at least one sidewall (34) extending from the perimeter of the back wall (32) and a lip (36) extending inwardly from the outer edge of the at least one sidewall (34) to removably retain the portable electronic device (29) within the protective casing (30). The lip (36) forms a front opening to provide access to the touch screen of the portable electronic device. The associated portable electronic device (29) is inserted and received within an interior space of the protective casing (30) surrounded by the back wall (32), the sidewall (34) and the lip (36) while providing access to the touch screen of the portable electronic device (29). The protective cover (30) may be comprised of a flexible or inflexible single covering where the associated portable electronic device (29) may easily slip into the protective cover (30). The associated portable device (29) may include a cellular or non-cellular electronic device including, but not limited to, smartphones, mobile devices, wearable displays, portable computers, portable tablets or flexible display electronic devices.

In example embodiments, the protective cover (30) may include either a front opening or may be either partially or fully transparent so that a screen of the associated portable electronic device (29) is displayed and accessible. In embodiments utilizing a transparent protective cover (30), resilient plastics and/or other known materials provide for greater protection and accuracy in touch sensitivity.

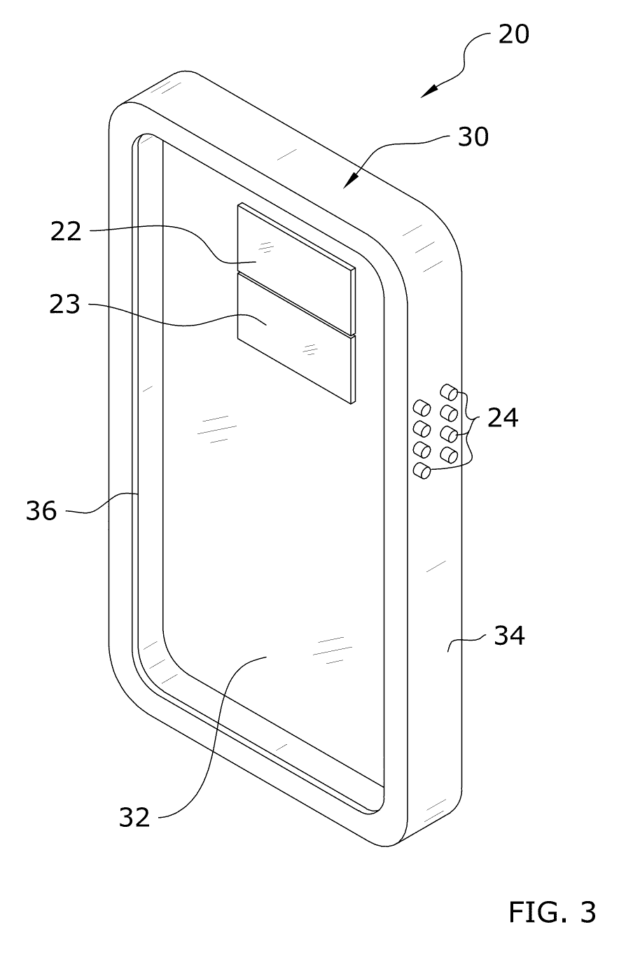

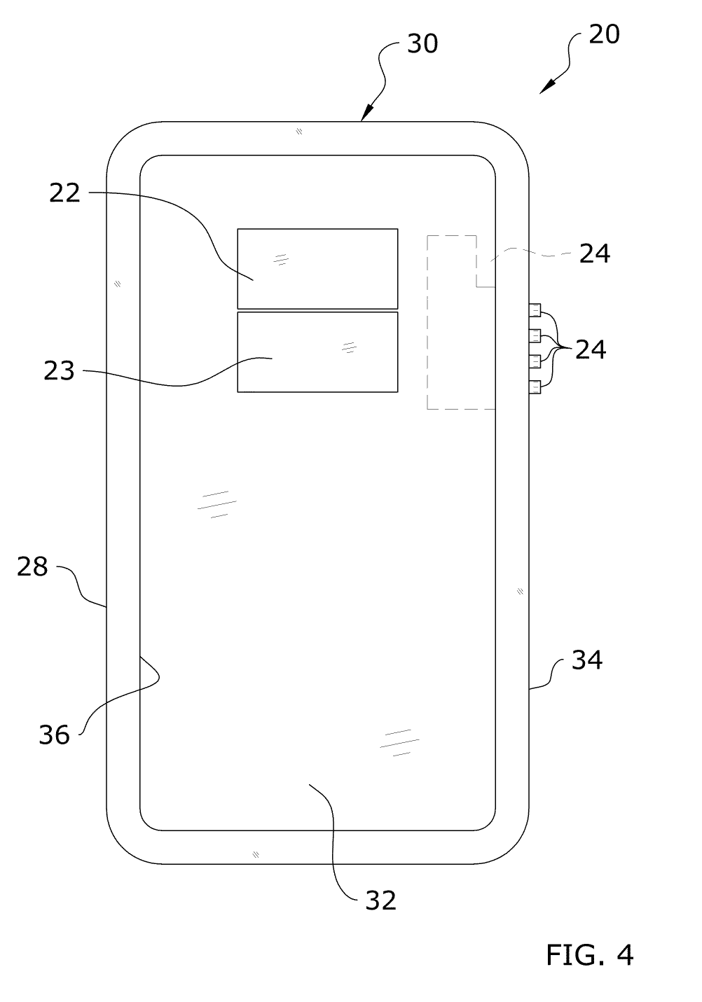

FIGS. 3 and 4 illustrate front views of the protective casing (30) of the braille reader and words translator portable device (20) in accordance with embodiments of the present invention. As shown in FIGS. 3 and 4, for example, a microprocessor module (22) and a memory module (23) are shown to be positioned in the upper central portion on the interior portion of the protective casing (30). Accordingly, the microprocessor module (22) and memory module (23) and other customizable electronic components (not shown) are housed within the inside surface of the back wall (32) of the proactive casing (30). While this particular location is contemplated in example embodiments, in other embodiments, the position of the microprocessor module (22) and the memory module (23) can be situated in other locations along the inner surface of the back wall (32) of the protective casing (30). The various electronic components such as the microprocessor module (22) may also be housed in the sidewall (34) or the lip (36) of the protective casing (30). In embodiments, the microprocessor module (22) and memory module (23) are parts of the language processing unit.

As shown in FIG. 4, for example, the braille cell (24) may be positioned in the upper right hand portion of the inside surface of the back wall (32) of the protective casing (30) adjacent and in proximity to the microprocessor module (22) and the memory module (23). In embodiments, pins of the braille cell (24) protrude outwardly from the sidewall (34) of the protective casing (30) as illustrated in FIGS. 1 through 6 of the drawings. Advantageously, for instance, six or eight pins are utilized to represent various braille characters corresponding to text portions of a particular language. In operation, combinations of the pins, either extending outward or contracted in a depressed position, represent the various braille characters. Once positioned, these braille characters may be comprehended by human touch finger sensing.

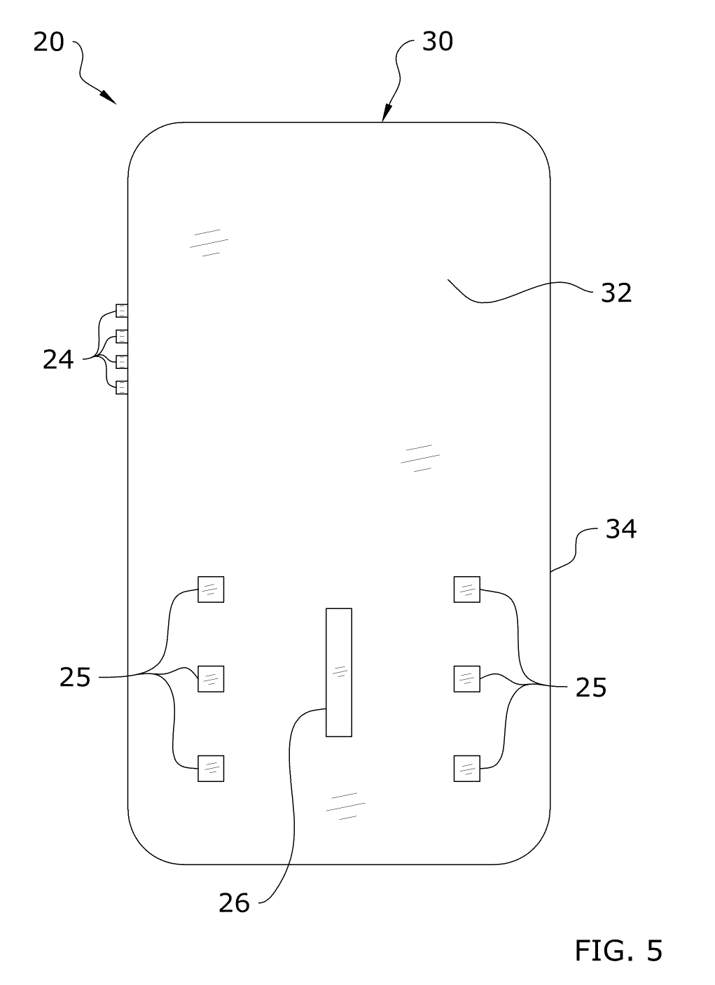

FIG. 5 illustrates a rear view of the protective casing (30) of the braille reader and words translator portable device (20) in accordance with embodiments of the present invention. As shown in FIG. 5, in embodiments, the braille keyboard (25) and enter key button (26) are positioned on the lower outer surface of the protective casing (30). For instance, for ease and comfort in use, the braille keyboard (25) may include six buttons arranged in two columns of evenly spaced three buttons. Advantageously, in an embodiment, the enter key button (26) may be larger in size and centrally positioned in between the two columns of three buttons of the braille keyboard (25).

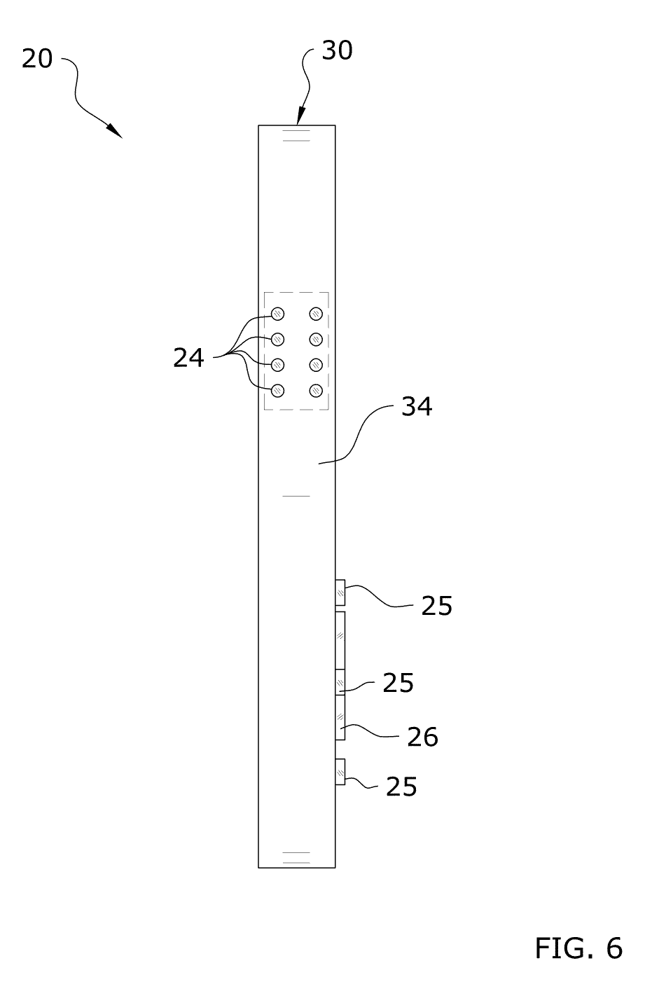

FIG. 6 illustrates a side view of the right side of the protective casing (30) of the braille reader and words translator portable device (20) in accordance with embodiments of the present invention. As shown in FIG. 6, for example, the pins of the braille cell (24) may be positioned to extend outwardly from the inside of the protective casing (30) to the outside of the protective casing (30). Furthermore, in certain embodiments, the braille cell (24) may include either six or eight pins arranged in two evenly spaced columns of three or four pins, respectively. Advantageously, the pin arrangement and spacing allows for ease and comfort in touch finger sensing.

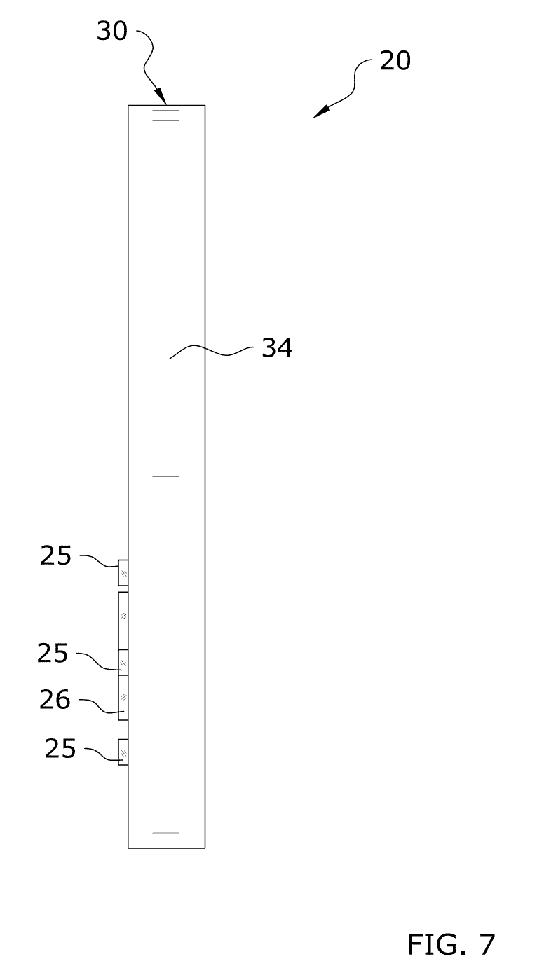

FIG. 7 illustrates a side view of the left side of the protective casing (30) of the braille reader and words translator portable device (20) in accordance with embodiments of the present invention. As shown in FIG. 7, in certain embodiments where the braille cell is located on the right side of the protective casing (30), the left side does not have additional buttons. Advantageously, this allows for ease in determination of the proper orientation of the braille reader (20) when being initially handled. In other embodiments where the Braille cell is located on the left side of the protective casing (30), the right side would not have additional buttons.

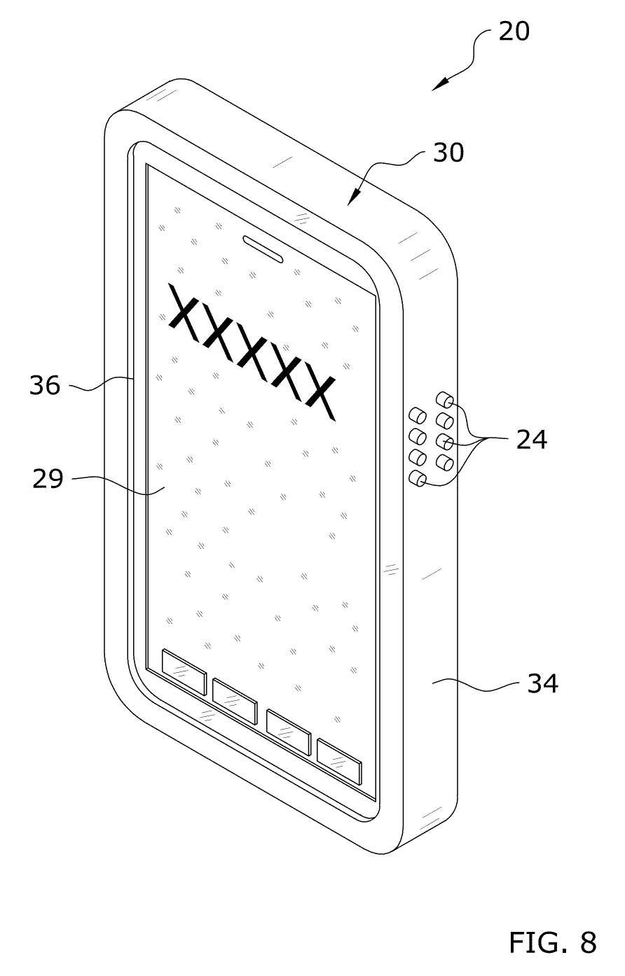

FIG. 8 illustrates a front upper perspective view of the braille reader and words translator portable device (20) in accordance with embodiments of the present invention. As shown in FIG. 8, text images of a selected language may be displayed on the associated electronic device (29) and then subsequently be converted into the corresponding braille equivalence on the pins of braille cell (24) located upon the protective covering (30). The braille conversion operation of the braille reader (20) is described in more detail in below paragraphs.

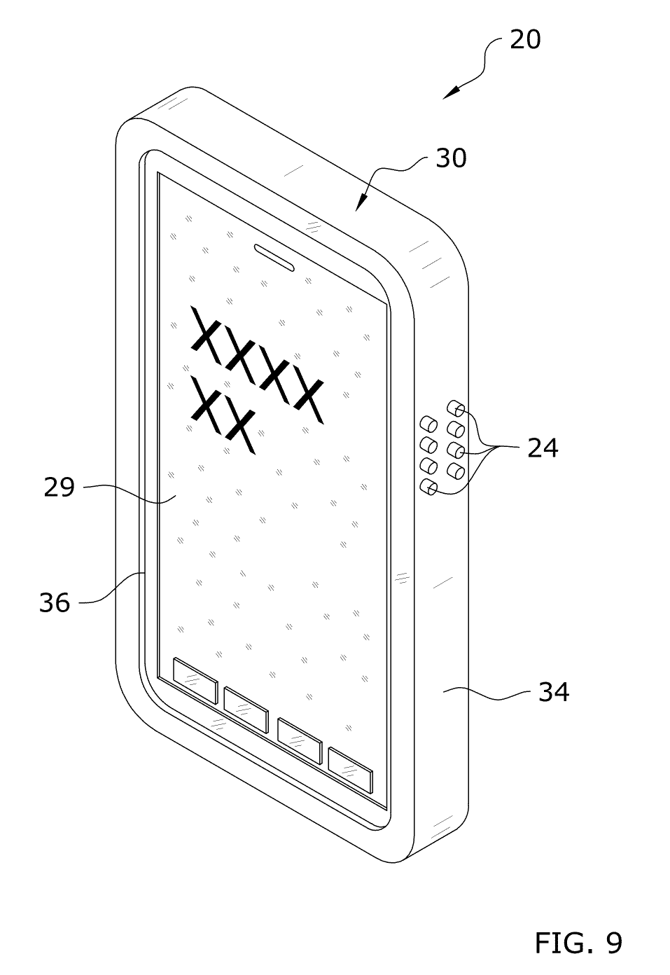

FIG. 9 illustrates a front upper perspective view of the braille reader and words translator portable device (20) in accordance with embodiments of the present invention. As shown in FIG. 9, for example a user selects the input language of the text images to be displayed on the associated electronic device (29) and then subsequently selects a different output language to be converted into the corresponding braille equivalence on the pins of braille cell (24) located upon the protective casing (30). The translation and braille conversion operation of the braille reader (20) is described in more detail in below paragraphs.

Additionally, while example embodiments, as shown in FIGS. 1-9, illustrate a protective casing (30) for an example smartphone, other associated portable devices (29) such as wearable displays, portable tablets or flexible display electronic devices are expressly contemplated to be interoperable in embodiments of the present invention.

C. Stand-Alone Multilingual Braille Reader with Words Translator.

Example embodiments of the present invention further include a portable stand-alone multilingual braille reader device with words translator. The braille reader (40) enables blind and visually impaired people to comprehend text images of various customizable language preferences by using braille.

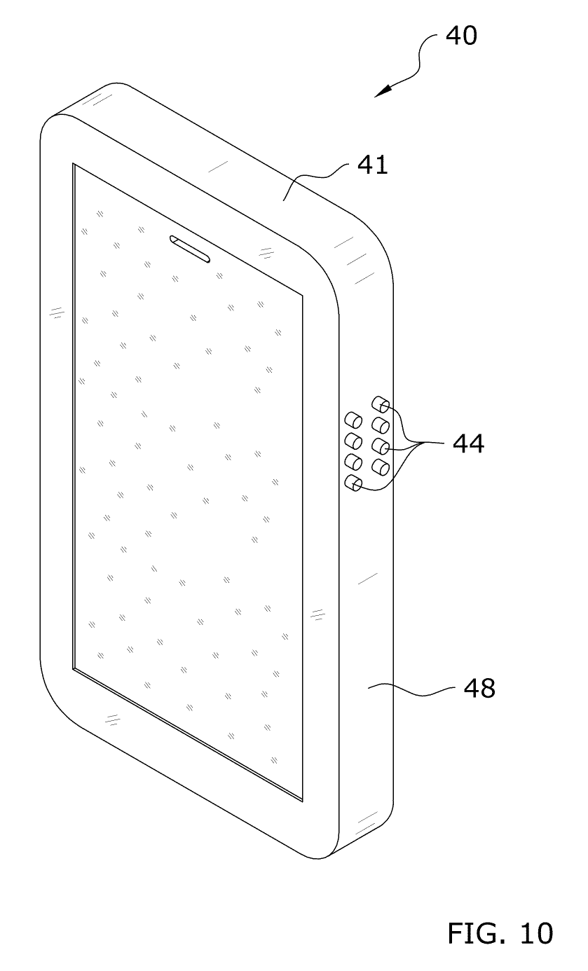

FIG. 10 illustrates a front outer perspective view of the braille reader and words translator portable device (40) in accordance with embodiments of the present invention. In embodiments, the braille reader (40) includes: a microprocessor module (42) (not seen), a memory module (43) (not seen), a braille cell (44), a braille keyboard (45) (not seen), and an enter key button (46) (not seen). In embodiments, the microprocessor module (42) and the memory module (43) are parts of the language processing unit.

Advantageously, these above components may be housed in a single portable device (41) similar to embodiments as described in FIGS. 1-9, without the necessity of an associated electronic device (e.g. smartphone), allowing for convenience in use as a portable braille electronic reader. The text images may be displayed using any conventional display technology including, but not limited to, LCD, OLED, or electrophoretic displays.

### D. Operation of Preferred Embodiment.

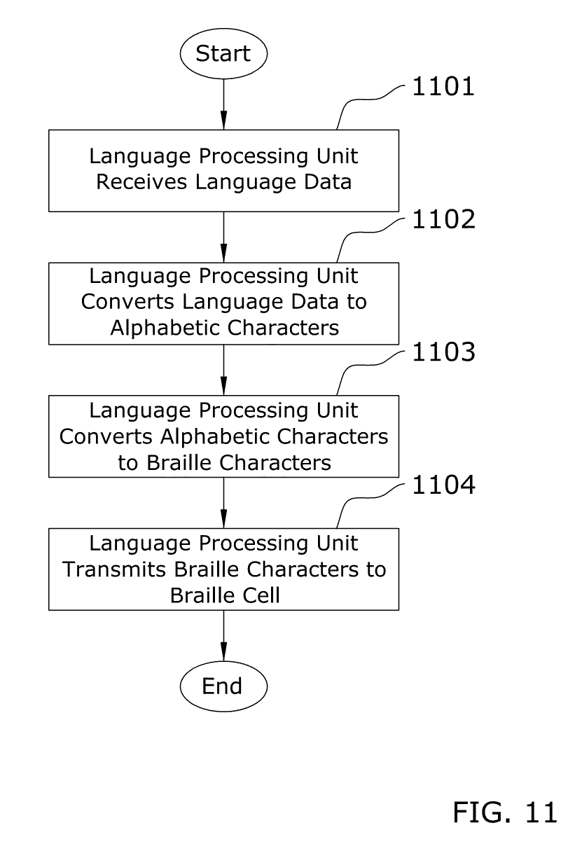

FIG. 11 shows a flow diagram of text image conversion in accordance with embodiments of the present invention. In Step 1101, text images are received at any time by the microprocessor module (22, 42) of the language processing unit. Advantageously, in embodiments, the microprocessor module (22, 42) functions in a continually “pulling” operation to detect and receive text images from the associated portable device (29). The receiving of text images may be through any known method of wireless transfer of data including, for example, Bluetooth, infrared, radio frequency, ultrasound, and Wi-Fi. Alternatively, the receiving of text images may be through any know method of wired connectivity including cable (e.g. USB cable) or storage devices (e.g. flash memory).

In Step 1102, when the text image is received, OCR (Optical Character Recognition) software stored in the memory module (23, 43) of the language processing unit is executed so that the microprocessor module (22, 42) may convert the text image into alphabetic (or alphanumeric) characters of a chosen language, and subsequently, in Step 1103, into corresponding braille characters. In Step 1104, the braille characters are transmitted to the braille cell (24, 44) by the microprocessor module (22, 42) of the language processing unit. Advantageously, in example embodiments, the braille characters are represented by six or eight pins, where combinations of the pins either extend outward or are contracted in a depressed position to characterize the various braille characters. Once positioned, these braille characters can be comprehended by human touch finger sensing.

In embodiments of the present invention, the braille reader (20, 40) provides for the capability to a user to choose the specific input language of the text images to be read and converted into braille characters. The input language selection may be accomplished by selection of a character on the braille keyboard (25).

For example, a user can select an input language of the text images as English if the text images are a portion of a book or article in English. Likewise, the user may choose to select the input language as French, if the text images are a portion of a book or article is in French. In example embodiments, English, French, German, Spanish, Italian, Arabic, Russian, or any other language (in customized settings) may be selected as an input language.

Moreover, the braille reader (20, 40) provides for the capability for a user to select one input text image language and a different output text image language. For instance, the user may set the language of the input text images, and the braille reader (20, 40), using software stored in the memory module (23, 43), would translate the input text images into the different output language before conversion to braille characters.

In embodiments, a user temporarily can pause the braille reader (20, 40) from processing by pressing the enter key button (26, 46). If the enter key button is pressed, the braille reader (20, 40) will pause and operate in a suspended waiting mode to anticipate further instructions (e.g. commands) to be entered by the user.

In example embodiments, a user can select one of at least ten distinct commands corresponding to various different options. In certain embodiments, different English characters can represent different commands, respectively. In other embodiments, other characters or symbols from different languages can be used to represent various commands. For instance, a particular command is entered by selecting a corresponding character on the braille keyboard and subsequently pressing the Enter key button. In certain embodiments, English, French, German, Spanish, Italian, Arabic, or Russian may be selected as an output language.

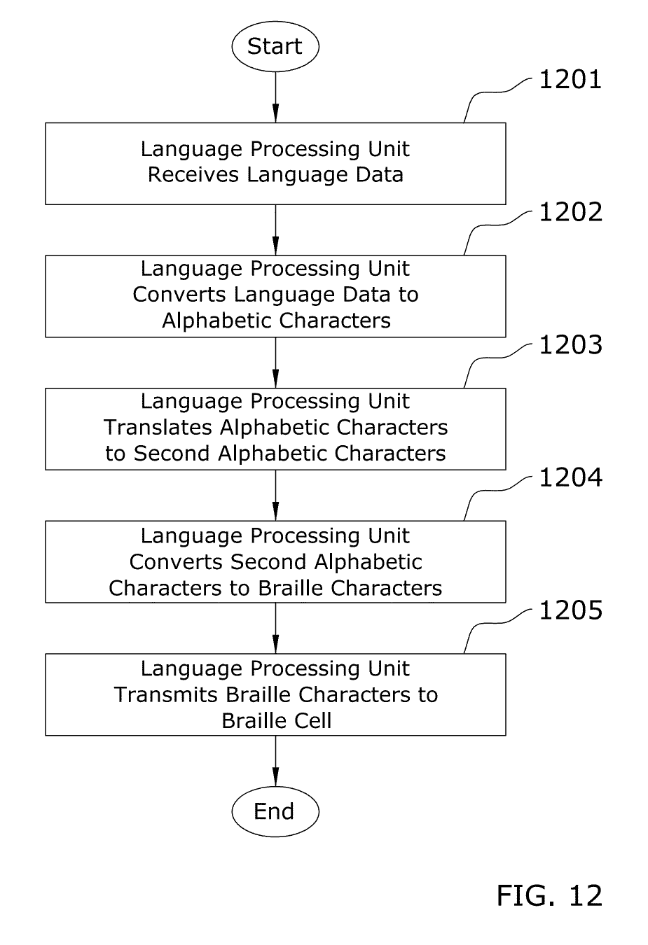

FIG. 12 shows a flow diagram of text image translation and conversion in accordance with embodiments of the present invention. In Step 1201, text images are received at any time by the microprocessor module (22, 42) of the language processing unit. Advantageously, in embodiments, the microprocessor module (22, 42) operates in a continually “pulling” operation to detect and receive text images from the associated portable device (29). The receiving of text images may be through any known method of wireless transfer of data including, for example, Bluetooth, infrared, radio frequency, ultrasound, and Wi-Fi. Alternatively, the receiving of text images may be through any know method of wired connectivity including cable (e.g. USB cable) or storage devices (e.g. flash memory).

In Step 1202, when the text image is received, OCR (Optical Character Recognition) software stored in the memory module (23, 43) of the language processing unit is executed, so that the microprocessor module (22, 42) may convert the text image into alphabetic (or alpha-numeric) characters of a chosen language.

In Step 1203, the microprocessor module (22, 42) translates the alphabetic characters to alphabetic characters of a different language, and subsequently, in Step 1104, microprocessor module (22, 42) converts the different alphabetic characters into corresponding braille characters.

In Step 1205, the braille characters are transmitted to the braille cell (24, 44) by the microprocessor module (22, 42) of the language processing unit. Advantageously, in example embodiments, the braille characters are represented by six or eight pins, where combinations of the pins either extend outward or are contracted in a depressed position to characterize the various braille characters. Once positioned, these braille characters can be comprehended by human touch finger sensing.

In operation, to use the above-described conversion and translation features, the user would perform a series of commands. For example, to select English as the input text language and French as the output text language for the braille cell (24, 44), the user would enter the following commands.

To pause the braille reader (20, 40), the user presses the enter key button (26, 46). Next, to change language options, the user inputs the “L” character, for example, using the braille keyboard (25, 45) and then presses the enter key button (26, 46) for confirmation. To change the selected input language to English, the user inputs the “E” character, for example, using the braille keyboard (25, 45), and then presses the enter key button (26, 46) for confirmation. To change the selected output language to French, the user inputs the “F” character, for example, using the braille keyboard (25, 45), and then presses the enter key button (26, 46) for confirmation.

The braille reader (20, 40) understands these above sequence of commands as that the input text is in the English language and that the user requires the braille reader (20, 40) to enable the translation plus conversion features, and send the generated French characters to the braille cell (24, 44).

In other options, a user may control the conversion speed between the text images and the outputted braille characters of the Braille cell (24, 44). Advantageously, for example, different levels of speed can be set to accommodate both slower and faster Braille readers. In operation, to change settings, a user would first pause the braille reader (20, 40) by selecting the enter key button (26, 46). Next, to increase speed, the user inputs the “T” character, for example, using the braille keyboard (25, 45) and then presses the enter key button (26, 46) for confirmation. In doing so, the speed of displaying the Braille characters is increased by ten percent from the default speed. In embodiments, the default speed can be set during design.

Similarly, to lower speed, the user inputs the “W” character, for example, using the braille keyboard (25, 45) and then presses the enter key (26, 46) for confirmation. In doing so, the speed of displaying the braille characters is decreased by ten percent of the default speed.

In embodiments, the predefined languages are, for example: “E”: English; “F”: French; “G”: German; “S”: Spanish; “I”: Italian, “A”: Arabic, and “R”: Russian. In one embodiment, pre-set commands include the following corresponding characters: “L”: change language (start language selection); “T”: faster (speed up the braille cell display); “W”: slower (slow down the braille cell display): “P”: previous word (go to previous word); “B” : beginning of the line (go to the beginning of the current text file); “X” : next line (got to next line); “J” : beginning of the file (go to the beginning of the current text file to be displayed); “N” : next file (go to the next text file to be displayed); “P” : stop (stop the portable device (20, 40)); “M” : resume (start portable device (20, 40); and “O”: reboot (reboot the portable device (20, 40).

During the design stage, the above commands or control options software are programmable and stored in the memory module (23, 43) of the language processing unit. Moreover, further commands can be added based on various user customizable preferences.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above.

All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A portable electronic device casing comprising:
a protective casing adapted to receive a portable electronic device;
a language processing unit attached to said protective casing; said language processing unit to process language data received from said portable electronic device; and
a braille cell to receive processed language data from said language translation processing unit.

2. The portable electronic device casing of claim 1, wherein said language processing unit includes a microprocessor module and a memory module.

3. The portable electronic device casing of claim 2, wherein said microprocessor module and said memory module are housed within an inside surface of said protective casing.

4. The portable electronic device casing of claim 1, wherein said protective casing includes a front opening or at least a partially transparent portion to display a screen of said portable electronic device.

5. The portable electronic device casing of claim 1, further including a braille keyboard.

6. The portable electronic device casing of claim 5, wherein said braille keyboard is located on a back portion of a back cover of said protective casing.

7. The portable electronic device casing of claim 1, further including a submission key button.

8. The portable electronic device casing of claim 7, wherein said submission key button is centrally located on a back portion of a back cover of said protective casing.

9. The portable electronic device casing of claim 1, wherein said braille cell includes six or eight movable pins.

10. The portable electronic device casing of claim 1, wherein said language processing unit receives said language data through wired or wireless transfer connections.

11. The portable electronic device casing of claim 2, wherein said microprocessor module and said memory module process said language data from said portable electronic device by: converting said language data to alphabetic characters, converting said alphabetic characters to braille characters, and transmitting said braille characters to said braille cell.

12. The portable electronic device casing of claim 2, wherein said microprocessor module and said memory module process said language data from said portable electronic device by: converting said language data to alphabetic characters, translating said alphabetic characters to a second alphabetic characters, converting said second alphabetic characters to braille characters, and transmitting said braille characters to said braille cell.

13. A method to read braille on a portable electronic device casing comprising:
receiving, by a protective casing, a portable electronic device;
processing, by a language processing unit, language data received from said portable electronic device; and
receiving, by a braille cell, processed language data from said language processing unit.

14. The method of claim 13, wherein said language processing unit includes a microprocessor module and a memory module, and wherein said microprocessor module and said memory module are housed within an inside surface of said casing.

15. The method of claim 13, wherein said protective casing includes a front opening or at least a partially transparent portion to display a screen of said portable electronic device.

16. The method of claim 13, further including a braille keyboard, wherein said braille keyboard is located on a back portion of a back cover of said protective casing.

17. The method of claim 13, further including a submission key button, wherein said submission key button is centrally located on a back portion of a back cover of said protective casing.

18. The method of claim 14, wherein said microprocessor module and said memory module process said language data from said portable electronic device by: converting said language data to alphabetic characters, converting said alphabetic characters to braille characters, and transmitting said braille characters to said braille cell.

19. The method of claim 14, wherein said microprocessor module and said memory module process said language data from said portable electronic device by: converting said language data to alphabetic characters, translating said alphabetic characters to a second alphabetic characters, converting said alphabetic characters to braille characters, and transmitting said braille characters to said braille cell.

20. A portable electronic device comprising:
a language processing unit to convert language data or convert and translate language data, said language processing unit including a microprocessor module and a memory module; and
a braille cell to receive said converted language data or said converted and translated language data from said language translation processing unit.
